(19) United States
(12) Patent Application Publication
(10) Pub. No.: US 2012/0047447 A1
(43) Pub. Date: Feb. 23, 2012

(54) Emotion based messaging system and statistical research tool

(76) Inventor: Saad Ul Haq, London (GB)

(21) Appl. No.: 12/805,873

(22) Filed: Aug. 23, 2010

(51) Int. Cl. G06F 3/01; G06F 15/16

(52) U.S. Cl. 715/752

(57) ABSTRACT

A system that allows users to convey their emotional state of mind by means of selecting their mood from a toolbar when using applications such as instant messaging, SMS, MMS, emails, blogs, commenting etc. Different moods appear as different icons or in a drop-down box as text. Emotion intensity can be changed by a sliding bar present on the toolbar. The sender will have the option to display their mood for that certain message as an emotion label displayed with the message and also by message text formatting: font face and color are emotion dependant whereas font size and tone (lighter/darker shades for the same color) are intensity dependant. This messaging technique allows the recipient to gauge better the sender mood, it can also be used to dynamically determine population mood and extract and plot statistical data on mood/emotion distribution maps, charts or graphs for analysis, interpretation, research and marketing.

This invention relates to the use of emotion labels and associated attributes that allow a user to specify their emotion on a certain subject at the time of writing thus enabling a more personal and effective communication with the recipient and also providing statistical data on the mood of a user over a certain period of time on a certain subject.

### CONVENTIONAL MESSAGING METHOD

Conventional text-based forms of communication over the internet, intranet, extranet and telecommunication networks are wide spread and are becoming increasingly common because of the increasing ease and advantages of accessing the internet in our daily life, i.e. cheaper connection costs and rates. Moreover, communication over the internet has many forms namely; electronic mail, instant messaging, blogs, forums and commenting systems. These methods of expressing one's self to another make up the mechanism of social networking, which too has increasing influence and importance in our daily life. In this patent, the word ‘messaging’ will be used to encompass all of the above forms. These methods involve typing text characters, symbols and/or attaching multimedia files. In this invention we will concentrate on text which usually forms the bulk of these messages.

The problem with such conventional messaging is the user's inability to fully express their emotion, mood or feeling without otherwise explicitly mentioning it. It is true then that emotion can thus be expressed by text if the emotion is mentioned within the body of the text, but on a large scale this method of reading each message to ascertain the perceived emotion is cumbersome. Searching for keywords seems to provide a solution. But, this method of identifying emotion-related words like ‘happy’ is in fact inaccurate as that particular word may not have been employed to describe the sender's emotion. For example, consider the following blog of a school student: “. . . remember how happy the teacher looked after we . . . ”, here mentioned is the word ‘happy’, but from the context it can be noticed that the sender has not specified their emotion, i.e. the student may be angry or sad for all we know but according to this keyword searching technique, the student will be considered happy. Another problem with this system is in the case when two or more contrasting emotion-related words appear together, for instance, if ‘happy’ and ‘sad’ appear together. There will ambiguity in the text inference.

### EMOTION BASED MESSAGING SYSTEM

The fact that text cannot fully express feeling is further emphasised by the fact that a spoken conversation can more aptly express the person's emotion than can text alone. The solution to expressing emotion or mood in text-based messaging calls for a system where users will specify their emotion, not by elaborating within the body of the text but rather concisely as a label and associated set of attributes. The label will appear with the message beside the sender's name and the regular date/time-of-send stamp. This label will thus conveniently serve as search criteria and it will provide a much more accurate expression of emotion to the recipient.

This patent specifies the use of single-worded emotion related words such as ‘happy’, ‘sad’, ‘angry’ etc. Also, the intensity of the emotion can be varied by means of a sliding bar which will be made available to the sender only. Moving this sliding bar would indicate how much of that particular mood the sender is feeling. How this will work is by the use of prefixes to the emotion related word. The following example is given for a certain emotion: A little happy, Happy, Very happy and Extremely happy. Please note that these prefixes will be made standard for all emotions and also that the extreme right of the sliding bar is the upper extreme of an emotion, i.e. extremely . . . , and the extreme left is the lower extreme, i.e. a little . . . .

### EMOTION TOOLBAR

By the use of a custom toolbar such as a text toolbar that contains font face, color, size and style (bold, italic, underlined etc.), this patent claims a similar independent toolbar that will enable the user to specify emotion by providing various options, menus and icons whose arrangement will be based on how this system of specifying mood works. The emotion toolbar will contain the most common emotions as smiley icons which can simply be clicked on if the user is feeling that way. We have limited the number of most common emotions to three; happy, sad and angry, for the sake of space and convenience. However, it is very much possible that the user is not feeling one of these three emotions, thus we have also created a drop-down menu that can be accessed by clicking on an arrow icon beside the three smileys. This menu will have many more emotions or moods written rather than depicted as smileys, which will be sub-classified into various headings for user convenience such as common, recent, latest, add new and search. Since there are a very large number of moods/emotions/feelings, it would be easier if they were classified in such a way. The ‘Common’ heading will contain no more than fifteen everyday emotions. ‘Recent’ will contain those moods that the user often uses and also those which he/she has used last. The heading ‘Latest’ will show all new emotions that have been added to the collection recently, since there are a very large number of emotions, it would not be possible to exhaustively think of every emotion and include it for use in the toolbar.

Thus, we have given the user the ability to upload an emotion if it does not already exist in our collection. This explains the purpose of the ‘Add new’ option, the ‘Search’ option will enable a user to find an emotion that he/she is feeling which is not displayed in the menu. The collection will be stored on the server or client machine depending on the application. The result of the search will depend on bandwidth availability, which in most cases will be almost instantaneous.

### EMOTION-INTENSITY SLIDING-BAR

The second section of the emotion toolbar will contain the emotion-intensity sliding-bar. The effect of moving this bar has already been discussed earlier. Suppose a person is feeling sad while writing a message, provided that he discloses this emotion willingly and sincerely, he will select the sad emoticon by clicking on it, by default it will be normal intensity (i.e. if intensity is not specified) neither high nor low and the label will be: Sad. If this user is very sad, then he/she will move the intensity bar towards the right. As he/she does this, a prefix will be added to the emotional word label automatically and dynamically, thus becoming: Very sad. This principle will work identically for all emotions.

### FURTHER OPTIONS

The third and final section of the toolbar will contain a ‘further options’ drop-down menu named: More. Once clicked, four options will be made available to the user: Formatting, Picture, Options and Help.

### FORMATTING OPTION

The ‘Formatting’ option enhances the mood chosen by the user by changing text formatting parameters such as font size, color, face, style (bold, italic, underlined, striked etc.) and also background color. This formatting will only apply to the body of the text. This option expresses emotion further by appealing to our human nature of attaching feeling to color. Any one font color and font face is associated with any one particular emotion. For some emotions, assigning color is very easy, such as for anger it is usually unanimously chosen as red, but others may be trickier. There will be a one-to-one relationship between color and font face with emotion so as to give each emotion a signature color and font face for easy recognition. We have limited any one color and all its shades to any one particular emotion. The darker and lighter shades for a color are important for specifying the intensity of the emotion when using the emotion-intensity varying-bar, i.e. darker shades for higher intensities and lighter shades for lower. However, by limiting any one color and all its shades to only one emotion, we have developed a problem, it is true that there are many different colors but in fact they are mostly shades of a handful of colors.

Thus we have limited the number of emotions that can be selected when the ‘Formatting’ option is enabled. This means that the number of emotions in the emotion dropdown menu will need to decrease to a handful. These handful of emotions will be the most major emotions, i.e. statistically those that are most used.

So if a user selects an emotion that is not one of these major emotions and he/she then enables the ‘Formatting’ option, he/she will be prompted to change his/her choice of emotional state. If a user selects the ‘Formatting’ option first and then opens the emotion dropdown menu, then the menu will simply be smaller and with less option as to when the ‘Formatting’ option is not chosen.

### EMOTION-RELATED PICTURE OPTION

The ‘Picture’ option will open a submenu Which will contain several emotion related pictures. These pictures/images will feature people displaying a certain emotion by their facial expression, body language and/or by implication. These pictures will also work with the emotion-intensity sliding bar by intensifying the facial expressions or body language of the people. Images of objects that invoke particular emotions may also be used. The emotion-related pictures/images will be standard and may also be slightly animated. The use of pictures will further enhance the user's ability to relay his/her emotion to the recipient by acting as visual aid. This picture would incite deeper feeling into the recipient than just merely mentioning an emotion; this implies that the use of sound or even video would have an even greater effect on the recipient. Although these would greatly enhance the expressing of an emotion, their use will be limited due to today's internet bandwidth. The use of these may cause much time spent in waiting for these messages to be opened or displayed. However, it will be a great tool in the near future.

Within this submenu, the user will also be given the option to view a larger collection of pictures whereby a small window will open up. If the user is still unsatisfied with the choices, they may upload their own image by browsing for its location on the hard drive. The standard built-in pictures will be stored on the client or server depending on the application.

### SETTINGS

Clicking on ‘Options’ will open a small window where the user will be given the choice to personalise the setting and position of the toolbar. Here, the user will also be able to write suggestion/complaints to the software developers if they feel so. Parameters like toolbar color and position and sliding bar color and position can be changed by a user. The user may also set a default emotion so that every time he/she messages, that particular emotion will be used automatically.

### HELP OPTION

The ‘Help’ option will provide assistance to the user by providing a topic-based user manual on the various functions and features. It will guide the user step-by-step for both ordinary and exceptional tasks and problems.

When this emotion toolbar will be used, the text formatting feature, the emotion related picture feature, the default emotion feature and all other features other than the emotion label, will be by default deactivated. However, they may be activated whenever the user requires. Also, by default, if no emotion is specified and the message is sent, then the label will read: Emotion unspecified.

The emotion toolbar will preferably be used in a client-server architecture where the toolbar will be provided as an integral feature to the user by default along with the other standard features of the messaging application. All toolbar related processing will be done at the server's site. All data related to the emotion toolbar including the collection of emotions and the emotion related pictures will therefore be stored on the server end. However the pictures can also be uploaded by the user from the user's machine, i.e. the client. The emotion toolbar may also be used as a downloadable plug-in that the user can install on their machine, i.e. the client. As a downloadable plug-in, it can also be used in other applications such as word processing.

### ADDITIONAL FEATURES AND ENHANCEMENTS

The additional features available to further enhance the emotion label are the use of text formatting, qualifying words and emotion related pictures. Although the emotion label concisely specifies emotion, these features help in describing the emotion from different prospective angles. Human beings have been defined to have five main human-senses, namely smell, touch, vision, hearing and taste. For other animals this may differ. Since emotion is influenced by how we feel to a certain environment, and that our environment is sensed through our five senses, then it can be said that emotion is triggered when one or more of our five senses is actively involved in sensing. If we define these human senses in terms of computer related parameters, it will be possible to create computer related emotion, i.e. it will be possible for the computer to express emotion in its own terms. For example, hearing can be appealed to by the use of sound, our vision by font face, color, size and background color. We can already see similar examples in our daily life, such as why statements of love are usually written in red. Now if these emotion-invoking computer-parameters can be manipulated in various permutations or amalgamations it may be possible to express a deeper, richer and more informed emotion between the sender and recipient via electronic media.

Other additional features include personalising features that will be discussed in the explanation of figures. There is also the search and filter feature which too will be discussed in the explanation of figures.

There is another additional feature provided to the user in which they can directly mention the topic to which he/she has chosen an emotion. This topic could include news, social events, political events, major discussion topics, major scientific and research topics and many more. This feature is optional. The sender can select an emotion he/she feels about either the subject mentioned/perceived in the message body, or with this additional feature, a topic chosen from a drop-down menu and displayed as an icon beside the emotion label. This icon will reveal the subject once the user clicks-on or hovers the mouse over it. This feature claims a menu containing major contemporary topics, events and subjects divided into various subheading categories such as ‘Human rights’. Thus there will be a limited number of available topics, however, as in the emotion menu, the user will be able to search a larger collection or if non-existent, then add their own and get it approved. The topics can also be country or region specific as required by the user. In the case of electronic mailing services, this feature may not be used as the subject field is present.

### CONSEQUENCES AND IMPACT

By accurately conveying emotion in an electronic message, it is possible to gather the overall mood or emotion of a population using that electronic media. This is further enhanced by the widespread use of social networking and electronic mail. It may also be applied to mobile phone based text-messaging services such as SMS and MMS. The application of these culminated statistics could be used in areas of research and analysis, commercial use, law and order, politics etc.

For example, the number of depressed individuals in a certain area could be found and monitored to prevent possible suicide. Also, the overall mood of a country's citizens could be analysed before, during or after parliamentary election and the passing of laws and bans. In the field of commercialisation, customer review and satisfaction for a new product on the market can be obtained by analysing their mood on this topic to optimise sales and can have a major impact for targeted marketing.

Apart from the above, users will be able to express themselves more effectively during messaging communication. There will be less ambiguity when messaging and the richness of emotion is being harnessed. The field of emotion in messaging can be used as a search criterion enabling people or governments to filter and search a population based on mood and emotion, this could lead to targeted advertising and door-to-door sales. A user who depicts more of a certain emotion than other emotions, would show more interest and would be more inclined to buy or inquire about a certain product that invokes that certain emotion. Thus emailing websites and social networking websites could display user-based advertising depending on that specific user's mood so that the effectiveness of that advertisement could be further enhanced.

The mood, emotion or feeling of a population on any given topic at any given time could be plotted on a map to show the distribution where each emotion appears as a different color. Currently, mapping of moods exists but it is run using a key word search technique which, as has been discussed, is inaccurate and can actually be misleading. Thus the use of emotion labels during messaging could provide a more accurate alternative.

### EXAMPLE

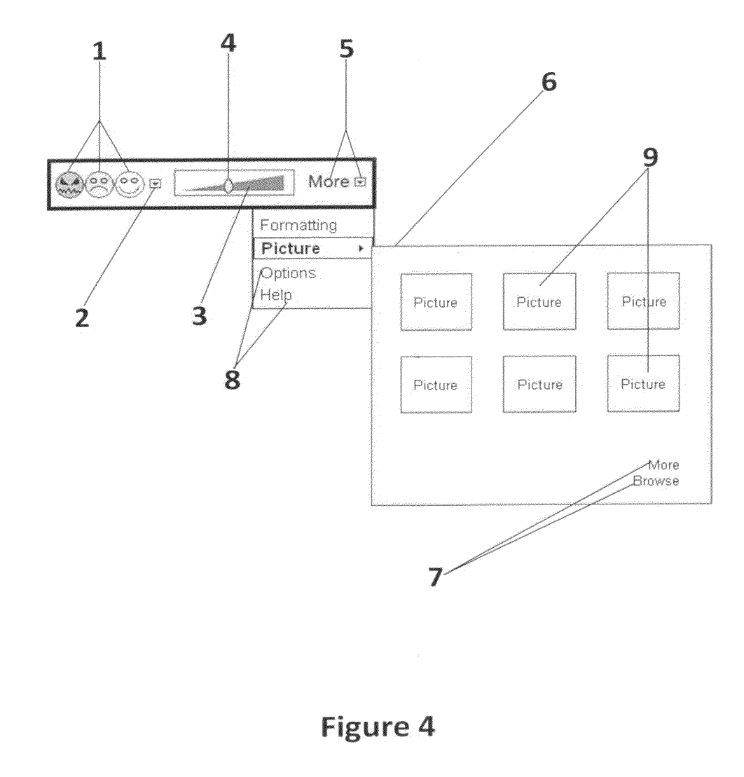

Here will be explained an example of how this emotion based system will work for an emailing service. In this example, a user is sad that he was not notified about an employment promotion but others in his department were despite him working as hard, he is writing an email to his friend in another department about this. The user will open the emailing service webpage and create a new email. He will select the recipient and enter the subject of the email: Promotion. The user will then choose an emotion that he thinks he is feeling about the subject of the email, which is in this case ‘Sad’. He will find it on the toolbar or select it from the emotion menu if the emotion is not one of the three major ones represented by emoticons. The user can then specify an intensity of this emotion, he chooses ‘Very Sad’ by sliding the bar to the extreme right. The user now begins to write the content of the message. He mentions that he is sad at this outcome and that he would have been very happy if he had been promoted as he had been working very hard and was looking forward to it. The user has now finished writing but he wants to express himself even further so he looks in the ‘More’ options. He decides to use all available features to express himself in the best way possible. Firstly, he selects the ‘Formatting feature’ and at once the content of the message is formatted to a dull blue, the background color also changes to make a good contrast, the font face is also changed to a different style. The user now returns to the same menu and clicks on ‘Picture’, a sub menu opens and displays several standard pictures for that particular emotion and intensity (this layout will be discussed in FIG. 4). However, the user does not think that these pictures explain his sadness enough so he decides to take a picture of himself sulking. He takes the picture and saves it to the hard drive. He then browses for the picture from the ‘Picture’ submenu and selects it. He now sends the message by clicking on send. In this specific example, the normal use of the system is explained. The ‘Topic’ feature was not used by this user as in emailing; the subject field would suffice. For the recipient, the email will have a ‘Very Sad’ label to it, thus immediately conveying the emotion. Once opened, the picture and text formatting will further convey the emotion. If the emotion label was not used, and the keyword search method was used to determine mood, then there would be ambivalence. It can be seen that the user mentioned both emotional words at least once; ‘Happy’ and ‘Sad’, thus settling on any one emotion may come down to the protocol of choosing the emotional word first or last used in the context as the overall mood—which is inaccurate. Furthermore, if the subject field of the email is searched using the same keyword technique, the results will again be false since the word ‘promotion’ reflects happiness but in fact the sender is sad (as he is referring to the promotion of another).

The invention will now be described solely by way of example and with reference to the accompanying drawings in which:

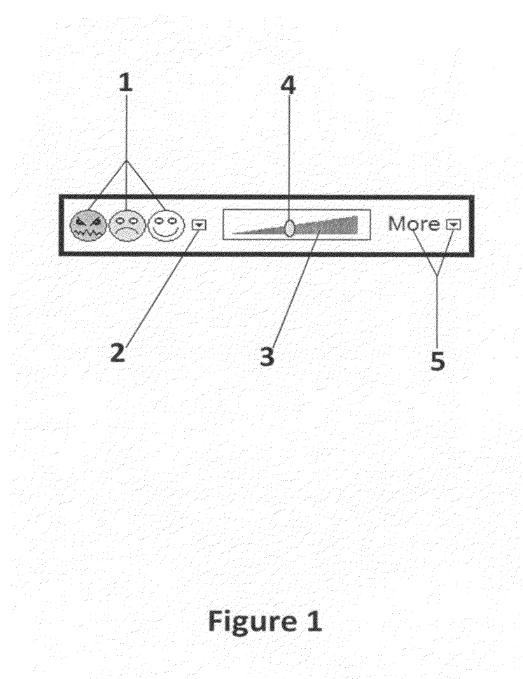

FIG. 1 shows the emotion toolbar, as it will be displayed for use in electronic mail, instant messaging, blogs, forums and commenting systems, containing the default emotion emoticons to the left, the emotion-intensity varying-bar in the centre and the further options menu to the right,

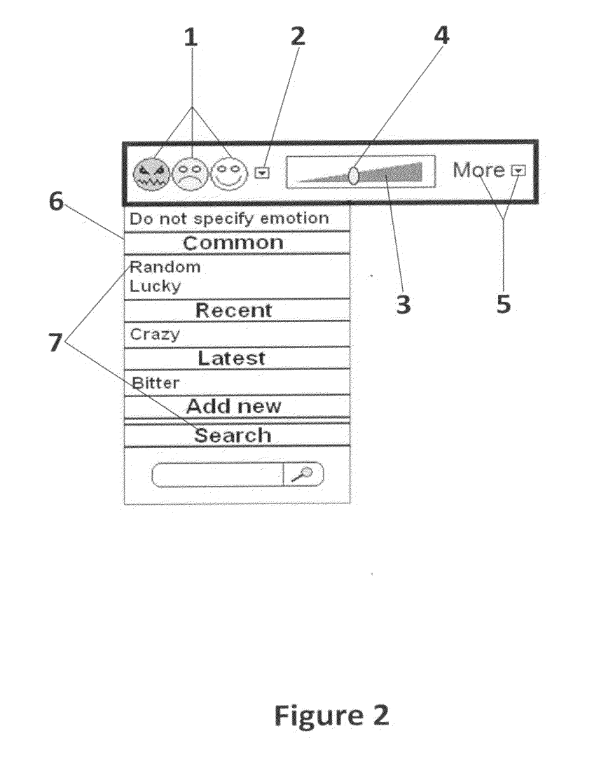

FIG. 2 shows the emotion toolbar with the emotion menu open and displaying the various options that can be selected from it,

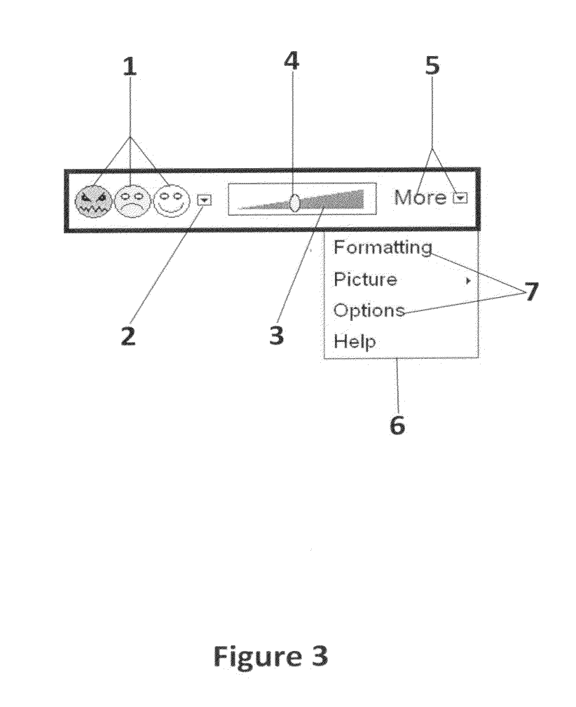

FIG. 3 shows the emotion toolbar with the ‘More’ menu open and displaying the various emotions and options that can be selected from it,

FIG. 4 shows the emotion toolbar with the ‘More’ menu open and the ‘Picture’ submenu open further and displaying the various pictures and options that can be selected from it,

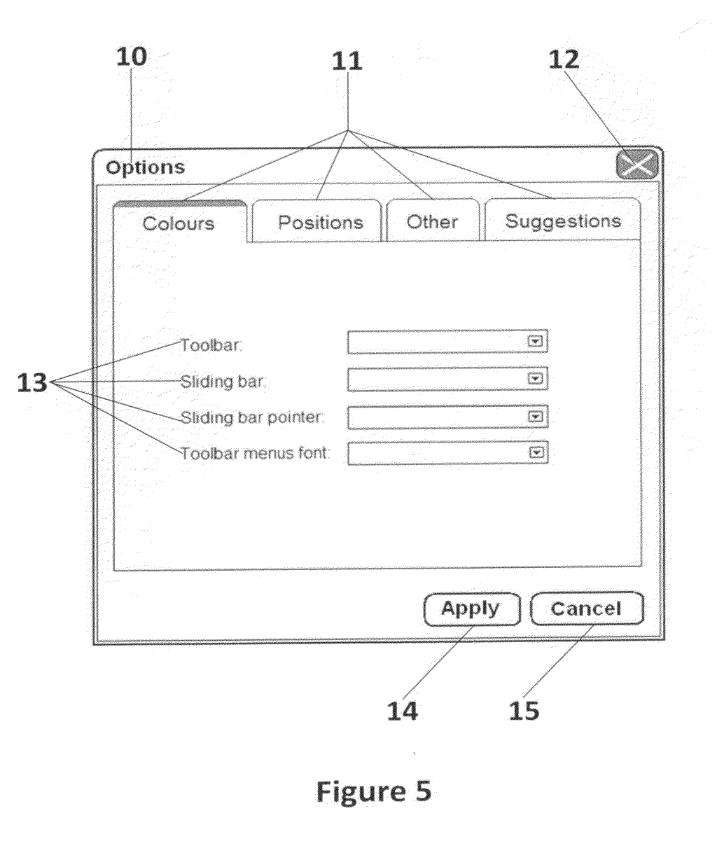

FIG. 5 shows a window that opens to the user when the ‘Options’ menu item is selected from the ‘More’ menu and also showing the various features the user can select and change,

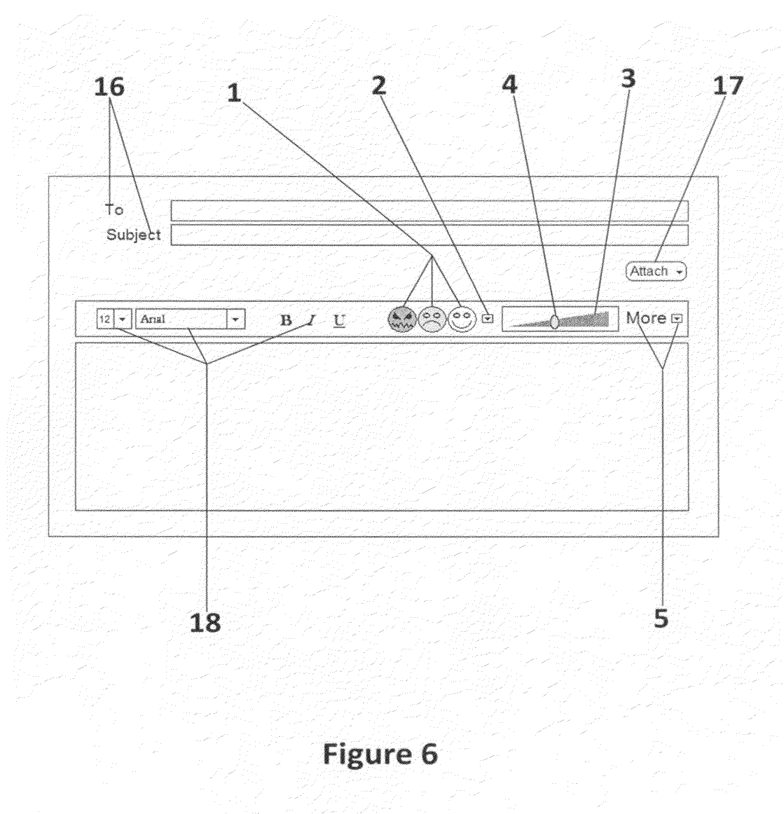

FIG. 6 shows an example of how the emotion toolbar can be incorporated into an electronic mail template as seen by a user sending mail,

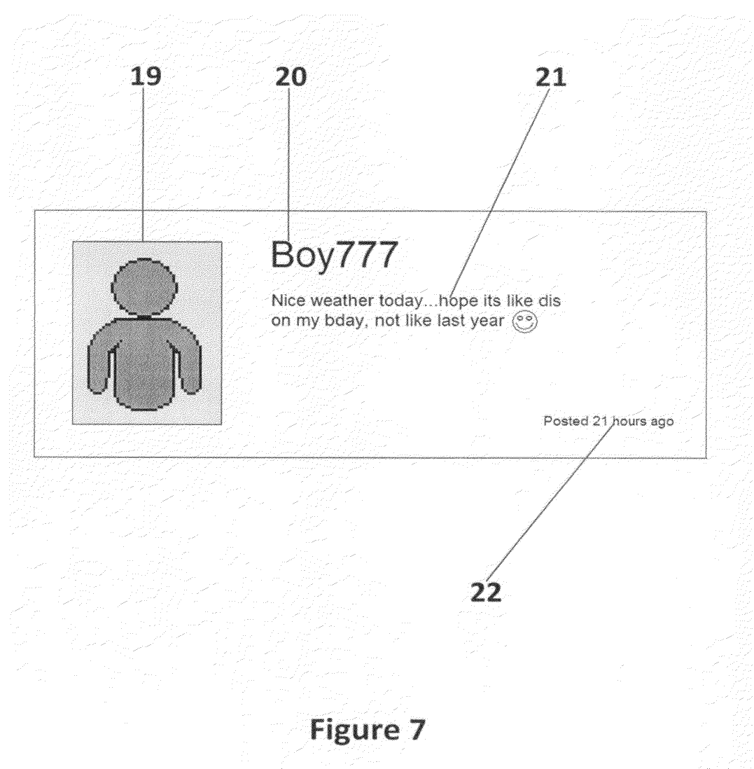

FIG. 7 shows an example of a standard status blog of a school student with similar format and components as seen on social networking sites and blogging sites,

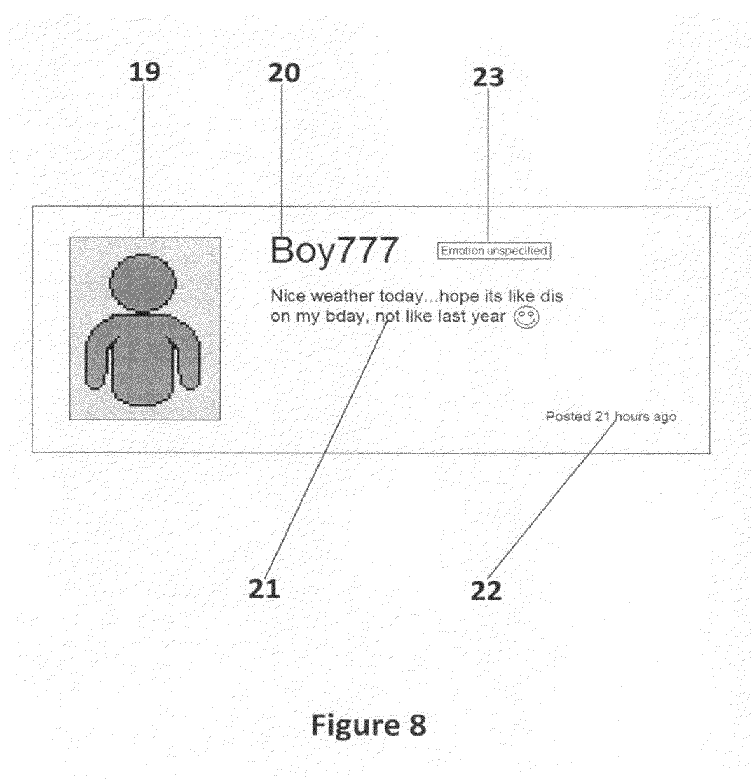

FIG. 8 shows an example of how using the emotion toolbar software and specifying no emotion will look for the recipient or viewer on a standard status blog,

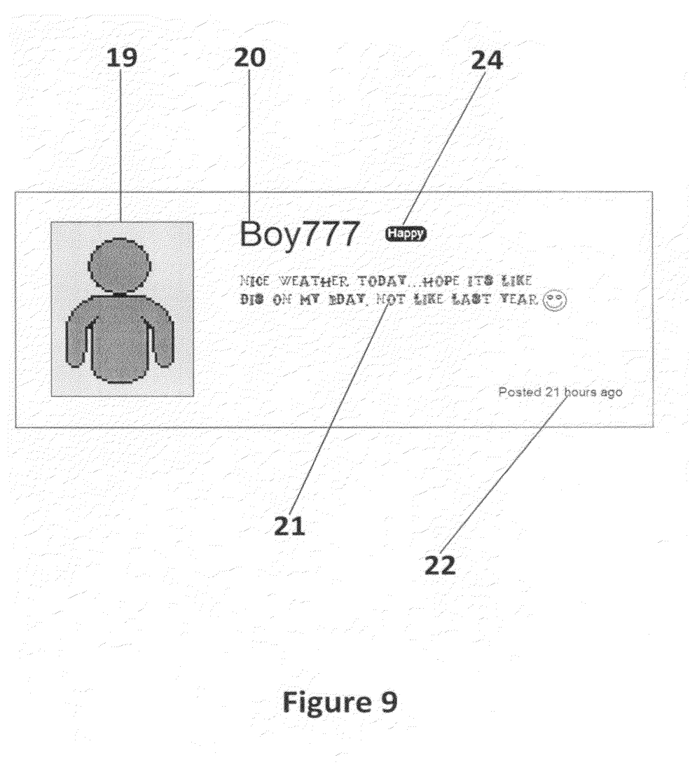

FIG. 9 shows an example of how using the emotion toolbar, specifying a ‘Happy’ emotion and using the ‘Formatting’ option will look for the recipient or viewer on a standard status blog,

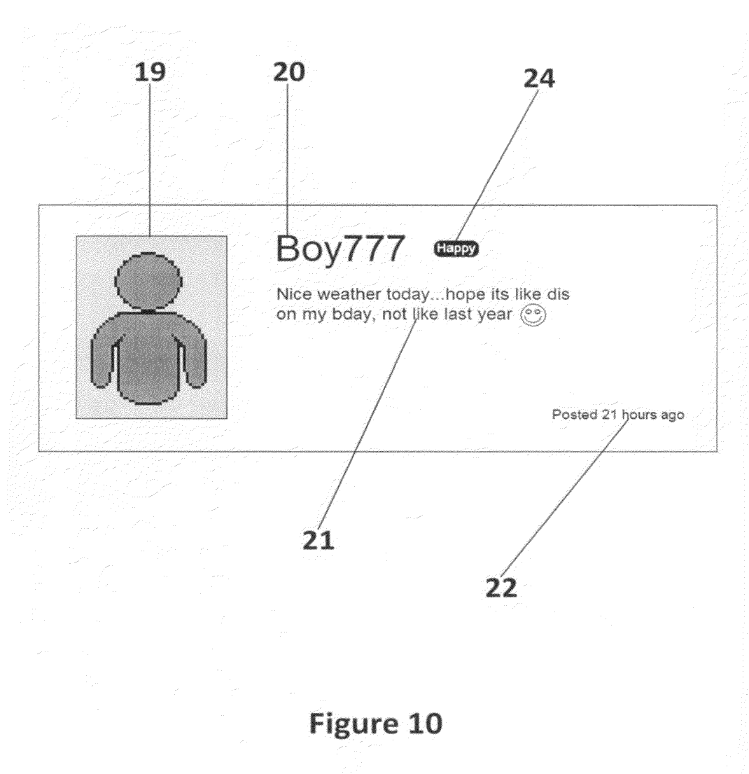

FIG. 10 shows an example of how using the emotion toolbar software and specifying a ‘Happy’ emotion will look for the recipient or viewer on a standard blog,

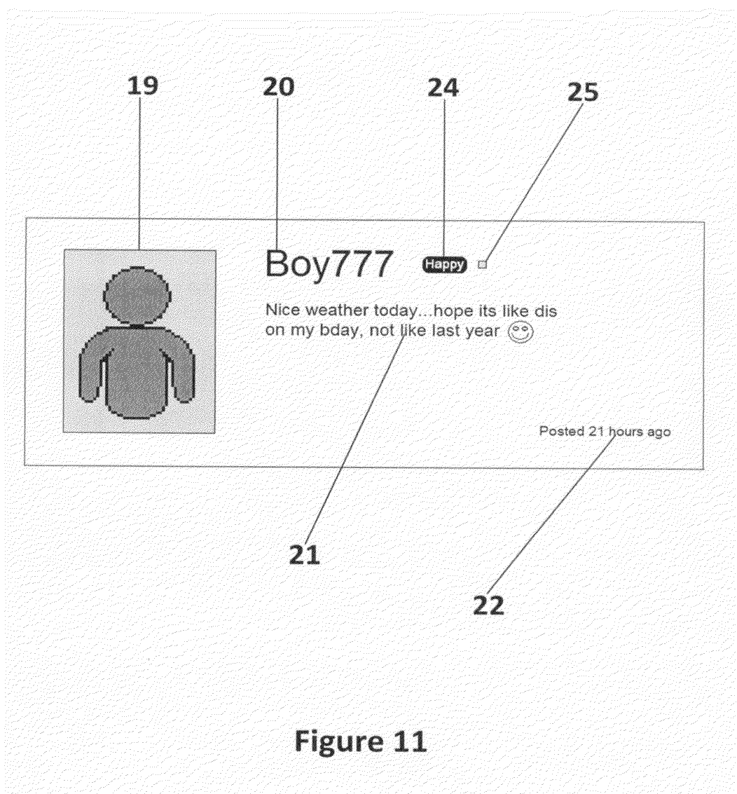

FIG. 11 shows an example of how using the emotion toolbar, specifying a ‘Happy’ emotion and using the ‘Picture’ option will look for the recipient or viewer on a standard blog,

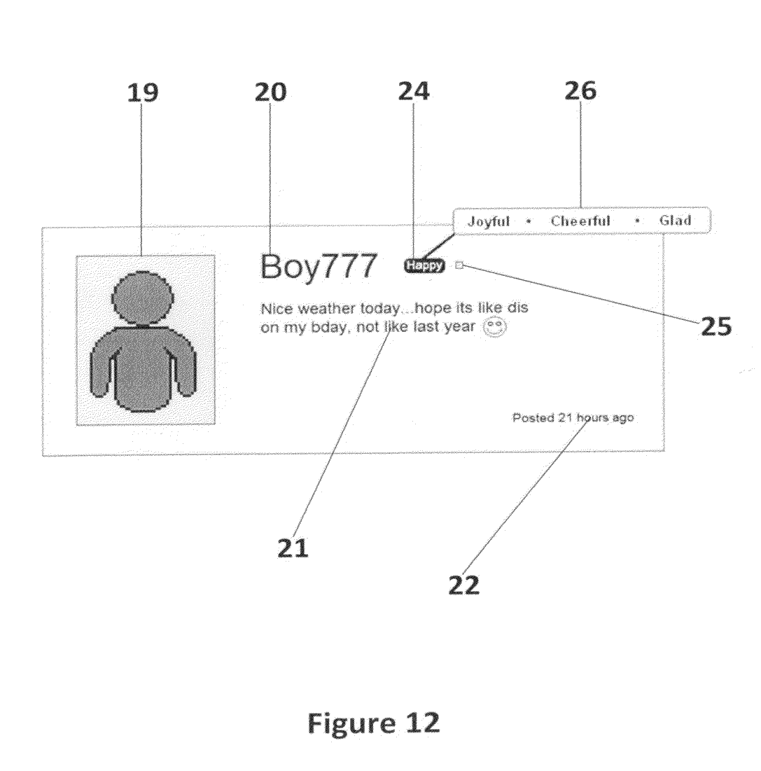

FIG. 12 shows an example of how using the emotion toolbar, specifying a ‘Happy’ emotion and using the ‘Picture’ option will look for the recipient on a standard blog while the user is hovering the mouse over the emotion label to display qualifying words for that emotion,

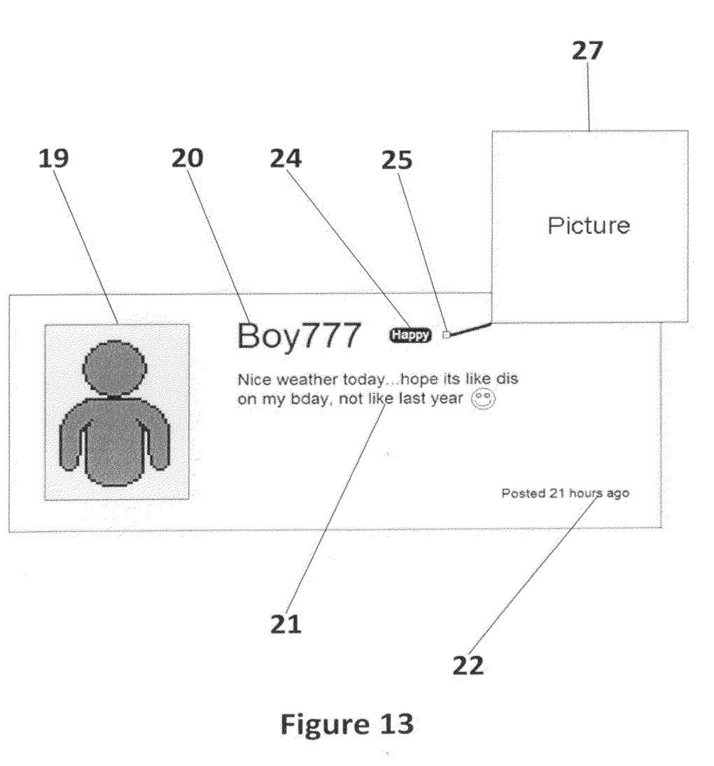

FIG. 13 shows an example of how using the emotion toolbar software, specifying a ‘Happy’ emotion and using the ‘Picture’ option will look for the recipient on a standard blog while the user is hovering the mouse over the picture icon to display the emotion related picture selected by the sender,

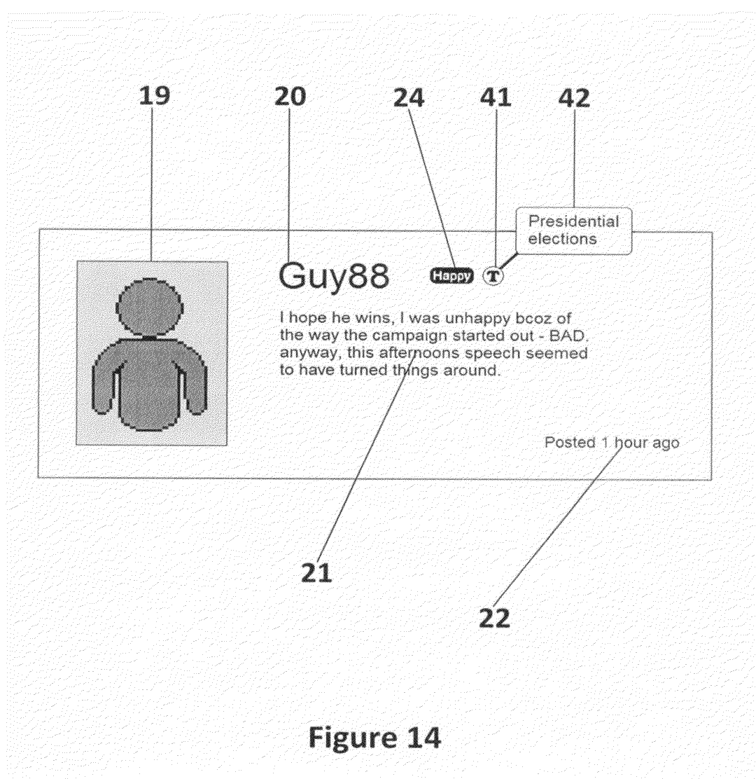

FIG. 14 shows an example of how using the emotion toolbar software, specifying a ‘Happy’ emotion and using the ‘Topic’ feature will look for the recipient or viewer on a standard status blog,

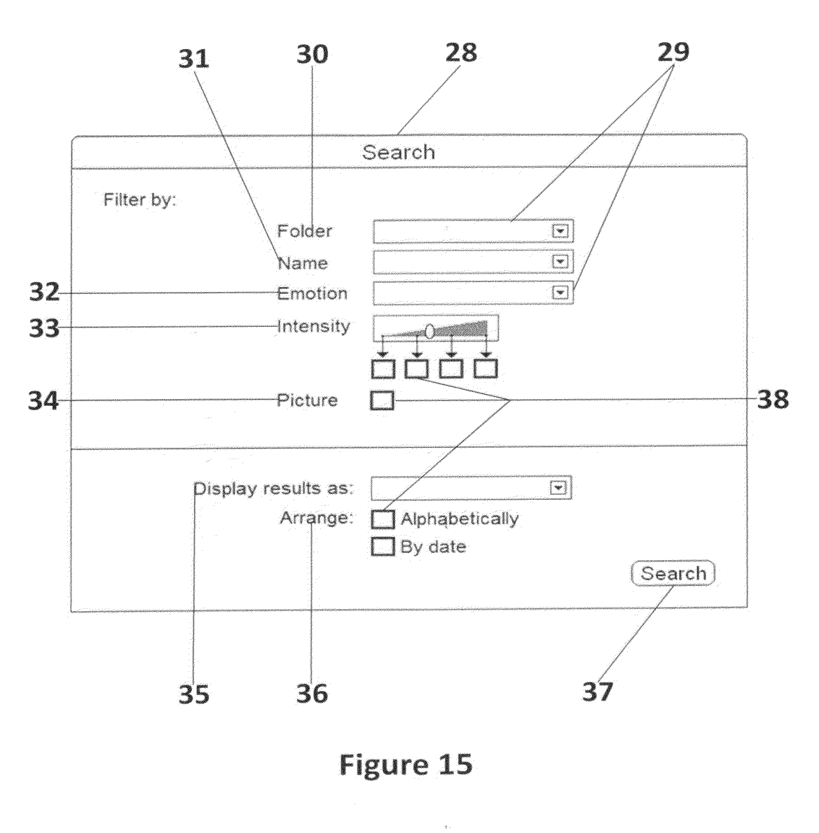

FIG. 15 shows a search window that can be opened from the ‘Other’ tab in the ‘Options’ window,

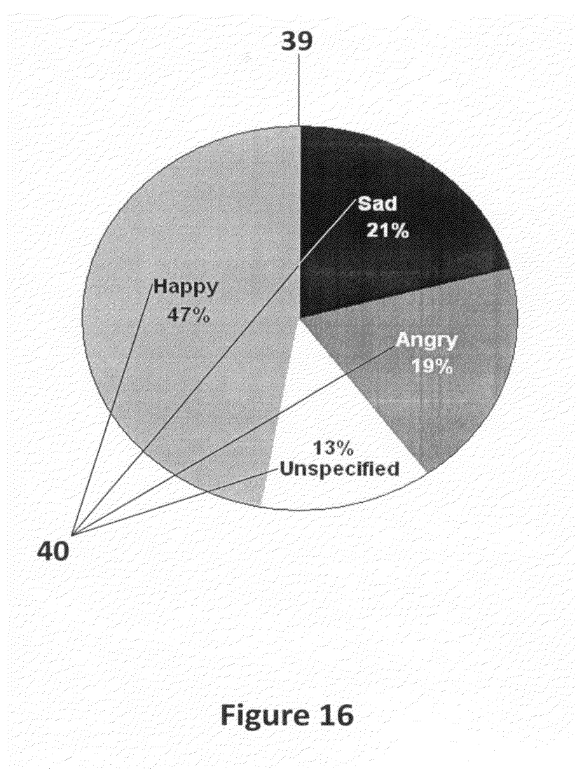

FIG. 16 shows an example of a diagrammatic view of the results of a search and filter feature that can be executed by a user,

FIG. 1 shows a default non-personalised emotion toolbar used to specify emotion. The emotion toolbar is meant to be indivisible and to be incorporated into email and other forms of messaging. Please note that this toolbar will only be visible to the sender of that message while he/she is composing it, after that, it will be replaced by a label, a picture icon, a topic icon or their combination.

Major emotions are represented by their corresponding smileys (1) which can be selected or not based on the user's choice. If selected and the message sent, then the recipient will be shown the corresponding label. The emotion menu icon (2) once pressed will open up a drop-down menu containing other emotions that are not one of the three major emotions displayed as emoticons on the emotion toolbar. Intensity sliding bar (3) will provide a scale to enable the user to vary the intensity of the emotion specified unless emotion unspecified, the sliding pointer (4) can directly be moved by the user along the sliding bar (3) to vary the emotion. Varying the emotion will result in the placement of a prefix to the emotion, such as ‘Very happy’. The options menu icon (5) once pressed will open up a drop-down menu containing various options and features.

FIG. 2 shows the drop-down menu that will appear when the emotion menu icon (2) is pressed. The various options will enable the user to access a larger variety of emotions or if the emotion is not in the collection, then it will enable the user to request to add a new emotion.

Active menu (6) is now open which is in this case the emotions menu containing various options (7) which will be explained in turn. The ‘Do not specify emotion’ is the equivalent of not selecting any emotion, it has been used in case an emotion was specified by the user who now no longer wants to specify emotion. The ‘Common’ heading contains emotions, moods or statuses that are the most frequently used when messaging, these can be obtained through statistics. The ‘Recent’ heading displays those emotions last used by this particular user, if no emotion has ever been used by this user then this section will remain empty, if a larger number of emotions have been used then the most recent will be displayed for the sake of space (up to ten). The ‘Latest’ heading will display those emotions recently added to the collection of emotions such as those requested by users (once approved by the authorising authority). The ‘Add new’ option once pressed will open a separate window where the user will read the rules for requesting for a new emotion such as searching the collection for this new emotion to see if it doesn't already exist. The user will then be asked to provide his/her name and email address after which they will type out the new emotion and then send this information to the developers email address electronically. The developers will check this emotion's existence, if it is new, then the emotion will be approved by the authorising authority, added to the ‘Latest’ heading and the requesting user will be sent a confirmation letter. The ‘Search’ heading contains a search bar that will enable the user to type an emotion letter by letter from the collection. The search is instantaneous and dynamic; it will dynamically display all matching results letter by letter as the user types. The results will be displayed below the bar under the same heading. Computer generated suggestions may also help the user in the case of misspelled emotions. The user will then be able to select the emotion.

FIG. 3 shows the drop-down menu that will appear when the ‘More’ options icon (5) is clicked on. The various options and features will allow the user to personalise the emotion toolbar or enhance the method in which the emotion will be displayed to the recipient.

Active menu (6) which is in this case the ‘More’ menu will display various sub options (7). These sub options include the feature ‘Formatting’ which will change the formatting parameters of the text content of the message. Parameters such as font color and font size along with background color will automatically be applied to the text based on the emotion and its relating intensity. Each emotion will have its own signature color (and shades) thus limiting the emotions to a handful. This means that the emotions menu that can be accessed by clicking on emotions menu icon (2) will be limited to a few selected emotions. The ‘Picture’ sub option will open a further sub menu. The purpose of this feature is for the sender to specify an emotion-related picture with the message to enhance his/her emotion. The ‘Options’ sub-option will open a window where the user may personalise the toolbar. The ‘Help’ option will also open a window where the user will be provided a step-by-step topic-based manual for carrying out different tasks while also providing explanation of the various features.

FIG. 4 shows the drop-down menu that will appear when the ‘Picture’ option of the ‘More’ sub options (8) is clicked on. The ‘More’ sub-options can be accessed by clicking on the ‘More’ menu icon (5). The active submenu (6) which is in this case the ‘Picture’ submenu contains various standard emotion-related pictures (9) which can be selected by the user to aid that specific emotion he/she has chosen. The active menu sub options (7) which are in this case the ‘Picture’ menu sub-options allow the user to specify a picture that is not one of the given pictures (9). The ‘More’ option of the active menu sub-options (7) will open a window which will contain an even larger collection of pictures (from the developers) depending on that specific emotion. Please note that the pictures may also be slightly animated (short duration animations). The ‘Browse’ option will allow the user to select a picture from one of the computer drives, i.e. those that are not from the toolbar developers.

FIG. 5 shows the active window (10) that will open when the ‘Options’ sub-option of the ‘More’ menu is clicked on. This window will be used to personalise position and color of the various toolbar constituents. It will also be used to file suggestions/complaints electronically in another one of the tabs (11). A search feature will also be present.

The various tabs (11) deal with different option which will be explained in turn. The ‘Colors’ tab will be open by default and the tab-order will be from left to right. The ‘Colors’ tab once clicked on if not already open will display tab options (13) which will deal with changing the color aspect of the emotion toolbar constituents. The ‘Positions’ tab will deal with changing the positioning of various toolbar constituents such as emoticons order (default order: angry then sad then happy) and the emotions menu, the sliding bar and lastly the ‘More’ options label and its icon for each others positions on the emotion toolbar. The orientation of the sliding bar and/or toolbar as a whole may also be changed from horizontal to vertical and vice versa. The ‘Other’ tab will deal with settings such as setting a default emotion for a particular user; this option once enabled will select that default emotion whenever the messaging service is opened. Also, the three default emotions represented by emoticons on the toolbar can be rearranged or even swapped for other emotion(s) from the emotions menu. Also, the toolbar menus font size and font face may be changed. Finally, there is a search feature, once selected, will open a separate window. This window will require the user to enter search criteria. This feature will enable the user to search or filter his/her messaging history of both sent and received messages based on emotion as the major criteria. The user will be able to view the results as a list or even graphically. This search feature will be explained further in FIG. 14. It is one of the major applications of this patent.

The last tab, ‘Suggestions’, will give the user the facility to file suggestions or complaints. The user will need to specify their name and email address.

All setting that have been changed in this window can be saved and applied by clicking ‘Apply’ command (14) which will close the window. The ‘Cancel’ command (15) can be used to cancel any changes that may have currently been made in this window. This window can be closed to return to the previous window by clicking on the ‘Close’ command icon (12).

FIG. 6 shows a standard electronic-mailing-service template with the emotions toolbar (1)(2)(3)(4)(5) incorporated. This view is for the sender as he/she writes the email. For the recipient the view will be different. This example is quintessential of how the sender will view the emotion toolbar and how it will be incorporated during sending for all types of messaging services such as blogs, comments etc. We will deal with how this system will look for the recipient in a later diagram(s). Standard electronic mail protocol of specifying recipient address and subject of message is shown (16). Services such as attaching documents or multimedia are summarised by the ‘Attach’ label and drop-down menu icon (17). Please note that all other email services are not shown. Standard text formatting features (18) common to almost all email services are also shown. Please note that all other formatting features are not shown. Emotion toolbar constituents are shown: emotion emoticons (1), emotions menu (2), sliding bar (3), sliding bar pointer (4) and ‘More’ options label and menu icon (5).

FIG. 7 shows a standard status blog template that summarises the basic layout of key constituents as seen in commenting systems, instant messaging windows and forum websites. The key features are the user alias or user ID (20) along with user ID picture (19). The content (21) of the message and the time of posting the message (22) are also shown. Please note that date/time of post and other minor features have been omitted. This diagram gives an example of how conventional messaging looks after being sent/posted, i.e. as viewed by the recipient or a viewer. This diagram has no emotion specified and the textual content does not specify any, thus there is ambiguity even if we consider the happy smiley inserted by the user. This smiley may not necessarily indicate the user mood but rather his habit or how, in this case, the user is looking at last year's disastrous birthday party as hilarious. Even if we do an emotional key-word search, the results may be ambiguous as discussed earlier.

The recipient is sceptical about how the user is feeling. By mentioning emotion and by enhancing it by text formatting and visual aid (pictures), the recipient will get a much better insight into the sender's feeling as he/she was typing and thus the purpose of the message is more aptly delivered.

FIG. 8 shows the same example as in FIG. 7 but here, the emotion toolbar was available and active when the sender was composing the message. In this case, no emotion was specified by the sender as seen by the emotion label (23).

FIG. 9 shows the same example as in FIG. 7 but as in FIG. 8, the emotion toolbar was available and active while the sender was composing the message. However in this case, the user had specified a happy emotion and also enabled the ‘Formatting’ option thus changing font formatting parameters for the message content (21). The happy emotion label (24) can be seen beside the user ID (20) at the beginning of the message.

This figure summarises the effect of specifying emotion and changing font formatting parameters can have on the recipient as to understanding how the sender felt. The use of this specific font is meant to incite the level of feeling of happiness the sender was feeling. Please note that font color and background color could not be shown so have been omitted. As for another emotion such as anger, the font color could be red and the font face could be chosen to have fiery edges around characters. The intensity of color and fiery edges (i.e. font face) would vary based on the level of anger as set by the sliding bar.

FIG. 10 shows the same example as in FIG. 7 but as in FIG. 9, the emotion toolbar was available and active while the sender was composing the message. However, here the user specified his/her emotion only without enabling the formatting feature. The emotion label (24) shows the user emotion and message content (21) here will be standard and default.

FIG. 11 shows the same example as in FIG. 7. As in FIG. 10, emotion had been specified as seen by the emotion label (24). The difference is in this case the user had also selected a picture when composing the message to act as visual aid. A small colored icon (25) has been placed next to the emotion label (24) to indicate a picture has been selected.

FIG. 12 shows the same example as in FIG. 7. As in FIG. 11, emotion had been specified as seen by the emotion label (24) and an emotion-related picture had also been assigned as visual aid as seen by the small colored icon (25). Here seen is a feature whereby emotion-qualifying-words (26) are displayed in a small popup window whenever the user hovers the mouse over the emotion label (24) or clicks it. The purpose of these words is to describe the emotion from different perspectives. These words are hence synonymous and will show different aspects of the emotion. These qualifying words will change with change in emotion and emotion intensity. This means that when the intensity of a particular emotion is varied, the words will become harder or softer based on the increase or decrease respectively. For example, a soft qualifying word for ‘angry’ could be ‘upset’, a normal qualifying word could be ‘cross’ and a hard qualifying word could be ‘infuriated’. Here, three normal-intensity qualifying words have been shown for ‘happy’. The purpose of these qualifying words is to enhance the effect by explaining the emotion more deeply. When the mouse is moved away from the emotion label (24), the emotion-qualifying-words (26) will disappear. Please note that no mouse pointer has been drawn here.

FIG. 13 shows the same example as in FIG. 7. As in FIG. 11, an emotion and a picture had been chosen and selected by the sender at the time of composing. Here seen is a feature where the user can hover over or click the small colored icon (25) in order to open and view the image as a small popup window (27). This visual aid boosts the effectiveness of specifying an emotion. These pictures or animations may be standard (from the software developer) or non-standard (from the user's own collection). The nature of our minds is that humans attach emotion to memories and furthermore that memories are short clips and images of our past, thus by using pictures, the user appeals to the recipients experience as a way of describing that emotion. Please note that no mouse pointer has been drawn here.

FIG. 14 shows a similar example of a status blog as in FIG. 7. As in FIGS. 12 and 13, also shown here is a small pop-up window (42) which has been opened by the user by hovering the mouse over the ‘Topic’ feature icon (41). This ‘Topic’ feature can either be present on the ‘Options’ menu or it may have its own icon and drop-down menu on the emotion toolbar, however, it has not been included in any of the emotion toolbar drawings. This figure shows how this feature, once enabled by the sender, would look to the recipient or viewer. If the viewing user does not hover the mouse over the icon, then the pop-up window (42) will not be displayed but rather the ‘Topic’ feature icon (41) alone would be. Sending user ID (20) and ID picture (19) are shown together with the message content (21) and message posting time (22) to form the basic layout and features for blogs, comments and instant messaging. The emotion label (24) shows the senders feelings on either the subject written within the pop-up window (42) (as is in this case) or if this feature is not selected, then the relevant and perceived subject specified in the message body.

If the ‘Topic’ feature icon (41) is not visible and there is an emotion label present, then the viewing user will know that the sender's emotion is implied or mentioned in the message body.

FIG. 15 shows a search window (28) from which the user can search, and filter sent or received messages based on emotion as the major search criteria. The user can also filter his/her contacts based on the same criteria. From the servers end, it will be possible to search and filter all emotion based messaging system users based on the emotion criteria, such as for all the approximately one billion users of Facebook or other such social networking websites.

For filtering sent messages, the user can achieve several results: he/she can view all messages sent according to emotion, he/she can view all sent messages to a particular contact(s) according to emotion, and finally he/she can view all sent messages and its relating emotion according to a particular contact. For filtering received messages, the user can achieve several results: he/she can view all messages received according to emotion, he/she can view all messages received from a particular contact according to emotion and finally he/she can view all messages received with its relating emotion according to a particular contact. For filtering contacts, the user can achieve the following result: he/she can view all contacts that have been sent messages or from which messages have been received according to emotion. Please note that the above achievable results have only included destination folder, contact name and emotion as criteria, the remaining criteria include emotion intensity and whether the sender had assigned an emotion related picture to the message or not. These two other criteria will further increase the achievable results; these results will not further be discussed as the above discussion summarises the topic.

Search criteria ‘Folder’ (30) and its drop-down menu (29) will contain the following destination folder choices: ‘Sent messages’, ‘Received messages’ or ‘All folders’. Search criteria ‘Name’ (31) and its drop-down menu (29) will contain the following option: ‘All contacts’, contact 1 (by name or ID), contact 2 (by name or ID), contact 3 (by name or ID) and so on for all the contacts. The ‘Emotion’ search criteria (32) and its drop-down menu (29) will contain: all emotions in the collection of emotions, the ‘Unspecified emotion’ and also ‘All emotions’. The ‘Intensity’ search criteria (33) and its four check-boxes (38) enable the user to select one of six possible choices: checking all boxes, checking none of the boxes, checking any 1 box, checking any 2 boxes, checking any 3 boxes or checking any 4 boxes. The user can select the boxes in any order. The search criteria ‘Picture’ (34) and its check-box (38) enable the user to further reduce the results to those messages where an emotion-related-picture has also been used.

Viewing options (35) enable the user to view the results either by list, pie chart, bar chart or by other graphical means based on user choice or on the type of search, i.e. some results may not be compatible to be viewed graphically. Arrangement options (36) enable the user to view the results alphabetically or in the order of date, i.e. latest first. Command button (37) will begin the search based on the entered search criteria and display the results based on the type and arrangement of display.

FIG. 16 shows a pie-chart (39) for the results of the search and filter option described in FIG. 15. It also shows how the use of the emotion toolbar can be analysed for a given number of messages. It is an example to show how statistical research and analysis can be carried out from the information contained in servers, i.e. the emotion of a message. The given diagram describes a miniature system where there are only 4 emotions viz. Happy, Sad, Angry and Unspecified. The search criteria for this diagram could be: All received messages over a year (January 2009-January 2010) from a particular contact. According to the diagram, it can be seen that this particular contact is happy most of the time when messaging and is angry less of the time. This is an example of how the use of the emotions toolbar when messaging can be used to derive data which can be plotted and studied for a particular reason such as in politics.

Pie-chart representation (39) contains the various emotions (40) in proportion to each other. The various emotions (40) can also be adapted for a bar-chart representation.

1. An emotion based electronic messaging system in the form of a toolbar that enables users to specify their emotion and its intensity on a certain topic by choosing one of many different emotions and by moving a pointer across a sliding bar respectively, the system having used a written label that would display the emotion before the body of the text to the recipient while also giving the sender additional features to enhance the chosen emotion,

2. An emotion based electronic messaging system as claimed in claim 1 wherein a moveable toolbar will contain the various options, menus and commands needed by the sender to specify an emotion, its intensity, a topic and an emotion related picture,

3. An emotion based electronic messaging system as claimed in claim 1 in which the emotion toolbar is by default placed seamlessly beside other text formatting toolbars such as those for font color, size, style (bold, underlined, italic) and so on,

4. An emotion based electronic messaging system as claimed in claim 1 in which the user can select their emotion either directly from the emotion toolbar or from a larger variety presented as text in a drop-down menu also present on the emotion toolbar,

5. An emotion based electronic messaging system as claimed in claim 1 wherein the user can search the complete collection of emotions or add their own (which would need formal approval from the service provider) if it does not already exist in the collection by means of a drop-down menu on the emotion toolbar,

6. An emotion based electronic messaging system as claimed in claim 1 wherein the emotion specified by the sender from the emotion toolbar is expressed to the recipient in the form of a textual label appropriately positioned in the message window above the text body of the message,

7. An emotion based electronic messaging system as claimed in claim 1 wherein the emotion toolbar also contains a sliding bar with an attached pointer in order for the sender to vary the intensity of the chosen emotion at the time of composing a message,

8. An emotion based electronic messaging system as claimed in claim 1 wherein the intensity of the chosen emotion is manifested to the recipient in the form of a prefix attached to the emotion label,

9. An emotion based electronic messaging system as claimed in claim 1 in which the sender is provided the feature of enabling emotion-specific text-formatting to the text body of the message to accompany and hence to further enrich and enhance the emotion label and its relating intensity,

10. An emotion based electronic messaging system as claimed in claim 1 in which the text formatting involves the change of the font face, size, color, style (bold, italic, underlined, striked etc.) and background color of the body of the message,

11. An emotion based electronic messaging system as claimed in claim 1 in which the text formatting applies a strict one-to-one relationship between font color and face with emotion, i.e. any one signature color to any one emotion without repeats,

12. An emotion based electronic messaging system as claimed in claim 1 in which the text formatting feature can also vary the signature color of an emotion to different shades of that color to manifest a different intensity of an emotion to the recipient,

13. An emotion based electronic messaging system as claimed in claim 1 wherein the sender can select a topic (contemporary issues, events, news and subjects), to which he has chosen an emotion, from a drop-down menu which can be opened from the emotion toolbar directly or from the ‘More’ drop-down menu,

14. An emotion based electronic messaging system as claimed in claim 1 in which the use of the ‘Topic’ feature by the sender is manifested in the form of an icon to the recipient/viewer which can be activated by the recipient/viewer to display the topic,

15. An emotion based electronic messaging system as claimed in claim 1 wherein the sender is also presented with an additional enhancement whereby he/she can select an emotion related picture to accompany the emotion label,

16. An emotion based electronic messaging system as claimed in claim 1 in wherein the emotion related picture can also be animated (short duration) or uploaded by the user from their own collection,

17. An emotion based electronic messaging system as claimed in claim 1 in which the use of an emotion related picture by the sender is manifested in the form of a small colored icon to the recipient/viewer which can be activated by the recipient/viewer to display the picture,

18. An emotion based electronic messaging system as claimed in claim 1 wherein qualifying words, which are synonymous, are used to further elaborate an emotion more deeply to the recipient,

19. An emotion based electronic messaging system as claimed in claim 1 in which the user can view the emotion related picture, the qualifying words and the topic by hovering the mouse pointer over the small colored icon, the emotion label and the topic icon respectively,

20. An emotion based electronic messaging system as claimed in claim 1 wherein the user can view the emotional history of themselves, a contact, the received messages folder or the sent messages folder,

21. An emotion based electronic messaging system as claimed in claim 1 wherein the emotional history refers to the statistics of messages received or sent based on the emotion label,

22. An emotion based electronic messaging system as claimed in claim 1 wherein commercial businesses may use the statistical information about the emotion of users in a country in order to carry out targeted advertising on messaging websites (electronic mailing websites, social networking, instant messaging, blogging websites) where the emotion toolbar may be used,

23. An emotion based electronic messaging system as claimed in claim 1 wherein commercial businesses can carry out targeted advertising of those goods that invoke a certain emotion oriented at those users who use that specific emotion more frequently than all other emotions thus increasing the chance of sale,

24. An emotion based electronic messaging system as claimed in claim 1 in which the statistical data about user emotion (emotional history) gathered from different servers can be used to carry out statistical research, analysis and comparison over time periods for emotions provoked by certain topics and events.
